(19) United States
(12) Patent Application Publication
(10) Pub. No.: US 2021/0262824 A1
(43) Pub. Date: Aug. 26, 2021

(54) PATH INFORMATION MANAGEMENT METHOD AND SERVER USING THE SAME

(71) Applicant: CUFIT INC., Seoul (KR)

(72) Inventor: Min Young Kim, Seoul (KR)

(73) Assignee: CUFIT INC., Seoul (KR)

(21) Appl. No.: 17/179,494

(22) Filed: Feb. 19, 2021

(30) Foreign Application Priority Data
Feb. 21, 2020 (KR) 10-2020-0021378

(51) Int. Cl. G01C 21/00; H04W 4/024; H04W 4/029; H04W 4/44

(52) U.S. Cl. CPC G01C 21/3804; H04W 4/44; H04W 4/029; H04W 4/024

(57) ABSTRACT

A path information management method comprises collecting, by a path information management server, a moving path of each of a plurality of user terminals that are being moved, comparing, by the path information management server, the collected moving path of each of the plurality of user terminals with a moving path in pre-stored map data and updating, by the path information management server, the pre-stored map data based on a moving path that does not exist in the pre-stored map data from among the moving paths of the plurality of user terminals, according to a result of the comparison.

### CROSS-REFERENCE TO RELATED APPLICATIONS

This application claims the benefits of Korean Patent Applications No. 10-2020-0021378, filed on Feb. 21, 2020, in the Korean Intellectual Property Office, the disclosures of which are incorporated herein in their entireties by reference.

### BACKGROUND

### 1. Field

The present disclosure relates to a path information management method, and a server using the same, and more particularly, to a path information management method capable of updating pre-stored map data based on a moving path that does not exist in the pre-stored map data from among collected moving paths of user terminals, and a server and a program using the path information management method.

### 2. Description of the Related Art

Because vehicle-oriented path guidance services already exist in a variety of ways, information about roads on which vehicles may travel is relatively well established.

However, the information about roads on which a vehicle may travel is limited to be utilized when a user moves for a fitness activity or moves with a personal mobility device.

### SUMMARY

Provided are path information management methods capable of updating pre-stored map data based on a moving path that does not exist in the pre-stored map data from among collected moving paths of user terminals, and servers using the path information management methods.

According to an aspect of an embodiment, a path information management method may comprise collecting, by a path information management server, a moving path of each of a plurality of user terminals that are being moved, comparing, by the path information management server, the collected moving path of each of the plurality of user terminals with a moving path in pre-stored map data and updating, by the path information management server, the pre-stored map data based on a moving path that does not exist in the pre-stored map data from among the moving paths of the plurality of user terminals, according to a result of the comparison.

According to an aspect of an embodiment, the updating of the pre-stored map data may comprise adding the moving path that does not exist in the pre-stored map data to the pre-stored map data when the moving path that does not exist in the pre-stored map data is collected from the plurality of user terminals more than a reference of the number of times.

According to an aspect of an embodiment, the reference of the number of times may be set differently according to a movement type selected by a user in each of the plurality of user terminals.

According to an aspect of an embodiment, the reference of the number of times may be set differently according to an area type of an area to which the moving path that does not exist in the pre-stored map data belongs.

According to an aspect of an embodiment, the updating of the pre-stored map data may comprise grouping moving paths that do not exist in the pre-stored map data within an adjacent range and selecting a moving path with the smallest change in the moving speed of a user terminal corresponding to each of the moving paths or a moving path with the shortest distance from among the grouped moving paths, and adding the selected moving path to the pre-stored map data.

According to an aspect of an embodiment, the path information management method may further comprise assigning, by the path information management server, the same driving type as the driving type used by a user corresponding to the added moving path that does not exist in the pre-stored map data to the added moving path that does not exist in the pre-stored map data.

According to an aspect of an embodiment, the path information management method may further comprise maintaining, by the path information management server, the added moving path that does not exist in the map data for a reference duration.

According to an aspect of an embodiment, the maintaining of the added moving path that does not exist in the map data for a reference duration may comprise excluding the added moving path that does not exist in the map data from the map data when a moving path corresponding to the added moving path that does not exist in the map data is not collected for the reference duration.

According to an aspect of an embodiment, a path information management server may comprise a moving path comparator configured to collect, from a plurality of user terminals that are being moved, a moving path of each of the plurality of user terminals, and to compare the moving path of each of the plurality of user terminals with a moving path in pre-stored map data and a map data updater configured to update the pre-stored map data based on a moving path that does not exist in the pre-stored map data from among the moving paths of the plurality of user terminals according to a result of the comparison.

Methods and devices according to embodiments may optimize map data according to various types of movements of a user with a user terminal by updating pre-stored map data based on a moving path that does not exist in the pre-stored map data from among collected moving paths of user terminals.

Furthermore, the methods and devices according to embodiments may appropriately set a reference of the number of times that is a criterion for determining whether to add a new moving path to map data according to a movement type selected by a user or an area type of an area to which a moving path to be added belongs.

In addition, the methods and devices according to embodiments may group candidates of new moving paths to be used for updating map data when there are multiple candidates, and select the most appropriate moving path in the group to be used for updating the map data.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a conceptual diagram of a path information management system according to an embodiment;

FIG. 2 is a block diagram of a path information management server shown in FIG. 1, according to an embodiment;

FIG. 3 is a flowchart of a path information management method according to an embodiment; and

FIG. 4 is a view illustrating a process of updating map data according to the path information management method shown in FIG. 3.

### DETAILED DESCRIPTION

The inventive concept may be variously modified and have various embodiments, so that specific embodiments will be illustrated in the drawings and described in the detailed description. However, this does not limit the inventive concept to specific embodiments, and it should be understood that the inventive concept covers all the modifications, equivalents and replacements included within the idea and technical scope of the inventive concept.

In describing the inventive concept, in the following description, a detailed explanation of known related technologies may be omitted to avoid unnecessarily obscuring the subject matter of the present disclosure. In addition, numeral figures (e.g., 1, 2, and the like) used during describing the specification are just identification symbols for distinguishing one element from another element.

Further, in the specification, if it is described that one component is “connected” or “accesses” the other component, it is understood that the one component may be directly connected to or may directly access the other component but unless explicitly described to the contrary, another component may be “connected” or “access” between the components.

In addition, terms including “unit,” “er,” “or,” “module,” and the like disclosed in the specification mean a unit that processes at least one function or operation and this may be implemented by hardware or software such as a processor, a micro processor, a micro controller, a central processing unit (CPU), a graphics processing unit (GPU), an accelerated Processing unit (APU), a digital signal processor (DSP), an application specific integrated circuit (ASIC), and a field programmable gate array (FPGA) or a combination of hardware and software. Furthermore, the terms may be implemented in a form coupled to a memory that stores data necessary for processing at least one function or operation.

Moreover, it is intended to clarify that components in the specification are distinguished in terms of primary functions of the components. That is, two or more components to be described below may be provided to be combined to one component or one component may be provided to be divided into two or more components for each more subdivided function. In addition, each of the respective components to be described below may additionally perform some or all functions among functions which other components take charge of in addition to a primary function which each component takes charge of and some functions among the primary functions which the respective components take charge of are exclusively charged by other components to be performed, of course.

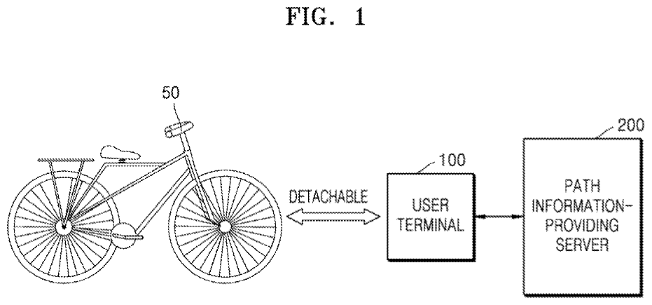

FIG. 1 is a conceptual diagram of a path information management system according to an embodiment.

Referring to FIG. 1, a path information management system 10 may include a user terminal 100 and a path information-providing server 200.

The location of the user terminal 100 may be moved while a user directly possesses the user terminal 100 or may be moved while being mounted on a moving member 50, according to various types of activities (i.e., movement types) of the user.

In FIG. 1, a case in which a user carrying the user terminal 100 moves using a bicycle is illustrated as an example. However, depending on the embodiment, the user may move using various types of activities (movement types), such as walking, trekking, running, bicycle riding, or personal mobility device.

According to an embodiment, the user terminal 100 may be implemented as various types of wireless communication devices capable of wireless communication (e.g., a to smartphone, a tablet PC, or a separate device to provide path information management service, etc.).

The user terminal 100 may position its own location.

According to an embodiment, the user terminal 100 may directly include a configuration for positioning its own location (e.g., a GPS module (when using a GPS signal for positioning) or a Bluetooth module (when using a Bluetooth beacon for positioning), etc.) or may receive location information from an external device (not shown).

The user terminal 100 may communicate with the path information-providing server 200 and transmit location information of the user terminal 100 to the path information-providing server 200.

The path information-providing server 200 may collect a moving path of the user terminal 100 transmitted from the user terminal 100 that is being moved.

The path information-providing server 200 may compare the collected moving path of the user terminal 100 with a moving path in map data previously stored in the path information-providing server 200.

When the moving path of the user terminal 100 is a moving path that does not exist in the pre-stored map data according to a result of the comparison, the path information-providing server 200 may update the pre-stored map data based on this.

In FIG. 1, for convenience of description, the path information-providing server 200 is shown to collect a moving path of one user terminal 100, but moving paths of a plurality of user terminals may be collected.

According to an embodiment, with a method of providing path information according to an embodiment, location information may be collected according to the driving of an app by the user terminal 100, and in this case, the path information-providing server 200 may be implemented in the form of an app server.

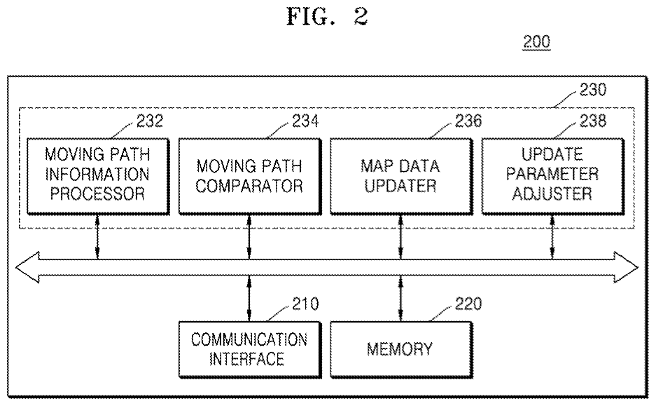

The detailed structure and operation of the path information-providing server 200 will be described later with reference to FIG. 2.

FIG. 2 is a block diagram of a path information management server shown in FIG. 1, according to an embodiment.

Referring to FIGS. 1 and 2, the path information management server 200 may include a communication interface 210, a memory 220, and a processor 230.

The communication interface 210 may interface communication between the path information management server 200 and the user terminal 100, and may process data or signals transmitted/received during the interfacing process.

The memory 220 may store data required to provide a path information management service of the path information management server 200 (e.g., map data), data required in the process of the processor 230, and data generated during or after processing by the processor 230.

According to an embodiment, different map data for each movement type may be stored in the memory 220 and managed separately.

According to an embodiment, the memory 220 may store a program for performing a path information management method according to an embodiment, and the memory 220 may be combined with the processor 230 to execute the program.

The processor 230 may include a moving path information processor 232, a moving path comparator 234, a map data updater 236, and an update parameter adjuster 238.

According to an embodiment, the moving path information processor 232, the moving path comparator 234, the map data updater 236, and the update parameter adjuster 238 may be divided into program code and a logical unit or set of hardware resources capable of executing the program code, and each does not necessarily mean physically connected code or a single type of hardware. In addition, the moving path information processor 232, the moving path comparator 234, the map data updater 236, and the update parameter adjuster 238 are distinguished to indicate that they may be separated functionally and logically, and do not necessarily mean that each of the configurations is classified as a separate physical device or written as separate code.

The moving path information processor 232 may process moving path information collected from a plurality of user terminals (e.g., 100) that are being moved, in a form that may be utilized by the moving path management server 200.

According to an embodiment, when location information over time is collected from each of a plurality of user terminals (e.g., 100), the moving path information processor 232 may divide the collected location information for each predetermined time period, and generate one piece of moving path information by linking the location information over time of each of the user terminals (e.g., 100) within the divided time period.

According to an embodiment, after mapping the location information to the map data stored in the memory 220 in the process of generating the moving path information, the moving path information processor 232 may correct at least some paths determined to be inaccurate location information and generate one moving path information. For example, when the location of the user terminal 100 according to the collected location information is above a building on the map data and cannot be established, the moving path information processor to 232 may correct the location of the user terminal 100 to the nearest possible location based on the collected location information.

According to an embodiment, the moving path comparator 234 may divide a moving path of a user terminal (e.g., 100) into units that may be compared with moving paths in the map data, in order to compare the moving path of the user terminal with the moving paths in the map data through the moving path comparator 234 afterwards.

The moving path comparator 234 may compare the collected moving paths of the plurality of user terminals (e.g., 100) with moving paths in the map data previously stored in the memory 220.

According to an embodiment, after mapping a collected moving path of a user terminal (e.g., 100) into pre-stored map data, the moving path comparator 234 may select moving paths in the pre-stored map data existing at a location adjacent to the collected moving path of the user terminal (e.g., 100).

The moving path comparator 234 may calculate a matching rate between each of the selected moving paths and the collected moving path of the user terminal (e.g., 100). In this case, the moving path comparator 234 may determine whether the collected moving path of the user terminal (e.g., 100) is a moving path existing in the pre-stored map data through whether the matching rate according to a result of the comparison result is equal to or greater than a reference value.

According to an embodiment, when different map data is managed separately for each movement type, the moving path comparator 234 may collect only moving paths of user terminals (e.g., 100) of the same movement type, and compare moving paths in map data of a corresponding movement type with the collected moving paths.

When it is determined that the collected moving paths of the user terminals (e.g., 100) are moving paths that do not exist in map data previously stored in the memory 220 according to a result of the comparison by the moving path comparator 234, the map data updater 236 may update the pre-stored map data based on the moving paths that do not exist in the map data.

According to an embodiment, when a moving path that does not exist in the pre-stored map data is collected from a plurality of user terminals (e.g., 100) more than a reference of the number of times, the map data updater 236 may add the collected moving paths to the pre-stored map data.

According to an embodiment, the map data updater 236 may monitor a moving path newly added to the pre-stored map data during a reference time, and may exclude the added moving path from the map data when there is no user terminal that has moved to the newly added moving path during the reference time or when the number of user terminals that have moved to the newly added moving path during the reference time is equal to or less than a reference value.

According to an embodiment, when different map data is managed separately for each movement type, the map data updater 236 may retrieve map data of the same movement type as the movement type of a user terminal that has moved in a collected moving path, and update only the retrieved map data.

The update parameter adjuster 238 may adjust various parameters used when the map data updater 236 updates map data previously stored in the memory 220.

According to an embodiment, the update parameter adjuster 238 may adjust a reference of the number of times used when the map data updater 236 determines whether to add a moving path that does not exist in the pre-stored map data.

For example, the update parameter adjuster 238 may set or adjust a reference of the number of times differently according to the movement type (e.g., walking, trekking, running, bicycle riding, or moving with a personal mobility device) selected by a user in a plurality of user terminals (e.g., 100). In this case, the update parameter adjuster 238 may add a moving path based on a strict reference by setting the reference of the number of times to be higher as the movement type has a relatively large moving path constraint (e.g., moving with a personal mobility device) for each movement type, and add a moving path based on a relaxed reference by setting the reference of the number of times to be lower as the movement type has a relatively small moving path constraint (e.g., moving by walking or trekking).

For example, the update parameter adjuster 238 may set or adjust a reference of the number of times differently according to an area type of an area to which a moving path that does not exist in pre-stored map data to be added belongs. In this case, the update parameter adjuster 238 may set the reference of the number of times to be lower as an area type of an area to which a moving path belongs has relatively large variability (e.g., bare land or vacant lot, etc.) to add a moving path based on a relaxed reference, or may set the reference of the number of times to be higher as an area type of an area to which a moving path belongs has relatively small variability (e.g., areas with buildings, etc.) to add an moving path based on a strict reference.

According to an embodiment, the update parameter adjuster 238 may adjust a reference time at which the map data updater 236 monitors a newly added moving path. For example, the update parameter adjuster 238 may adjust the reference time in proportion the number of times used as a reference when adding the moving path.

According to an embodiment, the moving path information management server 200 may be implemented without including at least some of the configurations illustrated in FIG. 2.

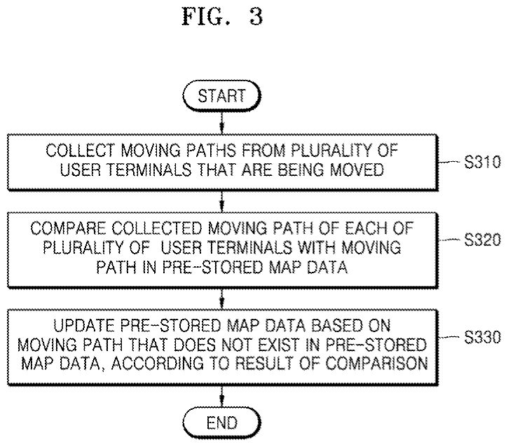

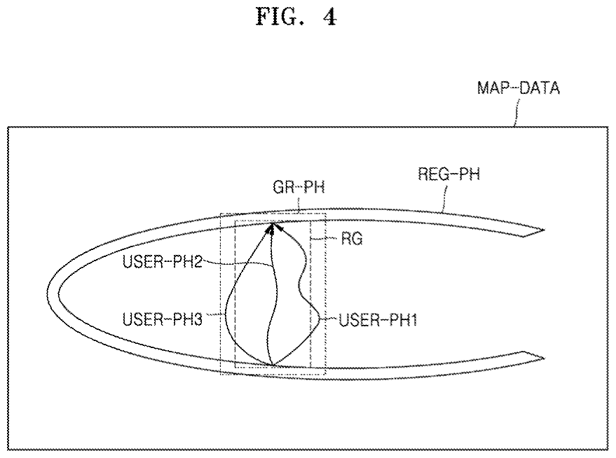

FIG. 3 is a flowchart of a path information management method according to an embodiment, and FIG. 4 is a view illustrating a process of updating map data according to the path information management method shown in FIG. 3.

Referring to FIGS. 1 to 4, in operation S310, the path information management server 200 may collect moving paths from a plurality of user terminals (e.g., 100) that are being moved.

In operation S320, the path information management server 200 may compare the collected moving path of each of the plurality of user terminals (e.g., 100) with a moving path in pre-stored map data.

Referring to FIG. 4 together, the path information management server 200 may compare collected moving paths (e.g., USER-PH1, USER-PH2, and USER-PH3) of the plurality of user terminals (e.g., 100) with a path REG-PH in pre-stored map data MAP-DATA.

According to a result of the comparison, when the collected moving paths (e.g., USER-PH1, USER-PH2, and USER-PH3) of the plurality of user terminals (e.g., 100) do not exist in the pre-stored map data and are collected more than a reference of the number of times, the path information management server 200 may determine to update the map data.

According to an embodiment, the path information management server 200 may differently set or adjust a reference of the number of times that is a criterion for determining whether to add the moving path (e.g., USER-PH2) according to an area type of an area RG to which the moving path (e.g., USER-PH2) that does not exist in the pre-stored map data to be added belongs (e.g., an area type such as bare land, vacant lot, area with buildings, etc.).

According to a result of the comparison in operation S320, in operation S330, the path information management server 200 may update the pre-stored map data based on the moving path that does not exist in the pre-stored map data.

According to an embodiment, the path information management server 200 may group collected moving paths (e.g., USER-PH1, USER-PH2, and USER-PH3) of a plurality of user terminals (e.g., 100) into one group (e.g., GR-PH) within an adjacent range.

According to an embodiment, the path information management server 200 may select any one of moving paths (e.g., USER-PH1, USER-PH2, and USER-PH3) of a plurality of user terminals (e.g., 100) in a group (e.g., GR-PH), and add the selected moving path to pre-stored map data. For example, the path information management server 200 may select a moving path (e.g., USER-PH2) with the smallest change in the moving speed of a user terminal corresponding to each of the moving paths (e.g., USER-PH1, USER-PH2, and USER-PH3) in the group (e.g., GR-PH) or a moving path (e.g., USER-PH2) with the shortest distance in the group (e.g., GR-PH), and add the selected moving path to the pre-stored map data.

According to an embodiment, moving paths of pre-stored map data may have a driving type for each moving path (e.g., a driving type that is not well known, a driving type that allows people to enjoy beautiful scenery, a driving type that is safe to move, or a dynamic driving type, etc.). In this case, when adding a new moving path to the pre-stored map data, the path information management server 200 may assign the same driving type as the driving type used by a user of a user terminal, which is a collection target of the newly added moving path.

According to another embodiment, when adding a new moving path, the path information management server 200 may assign a driving type of the added moving path based on a change in the movement speed of a user terminal that has moved in the added moving path. For example, when there is little change in the movement speed of the user terminal that has moved in the added moving path, the path information management server 200 may assign a driving type that is safe to move, and when a change in the movement speed of the user terminal that has moved in the added moving path is large, the path information management server 200 may assign a dynamic driving type.

A path information management method according to an embodiment may be implemented as program code and stored in a memory (e.g., 210 in FIG. 2), and the memory may be combined with a processor (e.g., 230 in FIG. 2) to perform a face identification method according to an embodiment.

Hereinabove, the disclosure has been described with reference to the preferred embodiments. However, it will be appreciated by one of ordinary skill in the art that various modifications and changes of the disclosure can be made without departing from the spirit and the scope of the inventive concept which are defined in the appended claims and their equivalents.

What is claimed is:

1. A path information management method comprising:
collecting, by a path information management server, a moving path of each of a plurality of user terminals that are being moved;
comparing, by the path information management server, the collected moving path of each of the plurality of user terminals with a moving path in pre-stored map data; and
updating, by the path information management server, the pre-stored map data based on a moving path that does not exist in the pre-stored map data from among the moving paths to of the plurality of user terminals, according to a result of the comparison.

2. The path information management method of claim 1, wherein the updating of the pre-stored map data comprises:
adding the moving path that does not exist in the pre-stored map data to the pre-stored map data when the moving path that does not exist in the pre-stored map data is collected from the plurality of user terminals more than a reference of the number of times.

3. The path information management method of claim 2, wherein the reference of the number of times is set differently according to a movement type selected by a user in each of the plurality of user terminals.

4. The path information management method of claim 2, wherein the reference of the number of times is set differently according to an area type of an area to which the moving path that does not exist in the pre-stored map data belongs.

5. The path information management method of claim 2, wherein the updating of the pre-stored map data comprises:
grouping moving paths that do not exist in the pre-stored map data within an adjacent range; and
selecting a moving path with the smallest change in the moving speed of a user terminal corresponding to each of the moving paths or a moving path with the shortest distance from among the grouped moving paths, and adding the selected moving path to the pre-stored map data.

6. The path information management method of claim 2, further comprising:
assigning, by the path information management server, the same driving type as the driving type used by a user corresponding to the added moving path that does not exist in the pre-stored map data to the added moving path that does not exist in the pre-stored map data.

7. The path information management method of claim 2, further comprising:
maintaining, by the path information management server, the added moving path that does not exist in the map data for a reference duration.

8. The path information management method of claim 7, wherein the maintaining of the added moving path that does not exist in the map data for a reference duration comprises:
excluding the added moving path that does not exist in the map data from the map data when a moving path corresponding to the added moving path that does not exist in the map data is not collected for the reference duration.

9. A path information management server comprising:
a moving path comparator configured to collect, from a plurality of user terminals that are being moved, a moving path of each of the plurality of user terminals, and to compare the moving path of each of the plurality of user terminals with a moving path in pre-stored map data; and
a map data updater configured to update the pre-stored map data based on a moving path that does not exist in the pre-stored map data from among the moving paths of the plurality of user terminals according to a result of the comparison.
